(19) United States
(12) Patent Application Publication
(10) Pub. No.: US 2014/0071707 A1
(43) Pub. Date: Mar. 13, 2014

(54) TEMPERATURE CONTROLLED VEHICLE LED LAMP

(71) Applicants: Charles Kent Booker, Clarendon Hills, IL (US); Todd Mitchell Nykerk, Holland, MI (US); John Eric Hall, Anderson, IN (US)

(72) Inventors: Charles Kent Booker, Clarendon Hills, IL (US); Todd Mitchell Nykerk, Holland, MI (US); John Eric Hall, Anderson, IN (US)

(21) Appl. No.: 13/611,198

(22) Filed: Sep. 12, 2012

(51) Int. Cl. F21V 29/02; B60Q 1/00; F21V 29/00

(52) U.S. Cl. CPC F21V 29/022; F21V 29/30; B60Q 1/00
USPC 362/545; 362/382; 362/249.02

(57) ABSTRACT

A temperature control system for a light emitting diode assembly and associated lamp comprises a circuit board for supporting one or more light emitting diodes and a housing supporting the circuit board. A coolant circulation path is routed through the housing. The coolant circulation path is connected to a source of a substantially constant temperature circulating coolant. The temperature of the coolant is maintained around the constant by an internal combustion engine and a radiator.

### BACKGROUND

1. Technical Field

The technical field relates generally vehicle lighting temperature control and more particularly to temperature control of light emitting diode based lamps.

2. Description of the Technical Field

Light emitting diodes (LED) are a type of semi-conductor device which emits light when electricity flows through them. LED efficiency in terms of conversion of power to light in the visible spectrum decreases with increasing temperature, with the decrease in efficiency accelerating dramatically when temperature increases above a particular threshold temperature. At the same time heat generation tends to increase. Removing heat from LEDs increasingly important at high power level operation of LEDs to keep operating temperature below the threshold.

LED temperature has been controlled using many of the same techniques used to control semi-conductor device temperature. These techniques generally rely on increasingly heavy heat sinks and more complex heat transfer systems as the amount of heat to be removed increases. A basic heat sink for an LED may provide a heat conducting metal substrate on which the LED is mounted. The metal substrate provides an increased area from heat is radiated to the environment. The metal substrate may be cast with heat radiating fins to increase its radiating area. If fins alone are insufficient to reject the heat produced by an LED a temperature actuated fan may be employed to force air across the fins. Improved transmission of heat from an LED to the heat sink may be achieved by circulation of a liquid between the LED and the heat sink. Such an LED package includes a built in finned radiator, circulation paths for the liquid coolant and electronics to detect temperature and to drive circulation of air and possibly coolant. Each gradation of heat removal adds to the expense and to the power consumption of the device. Such heat sinks tend to become increasingly heavy which is a consideration in motor vehicle applications.

### SUMMARY

A temperature control system for a light emitting diode assembly and associated comprises a circuit board for supporting one or more light emitting diodes and a housing supporting the circuit board. A coolant circulation path is routed through the housing. The coolant circulation path is provided with connectors for connection to an external source of a substantially constant temperature, circulating coolant. The coolant is maintained at a constant temperature by an internal combustion engine and an associated radiator.

### BRIEF DESCRIPTION OF THE DRAWINGS

FIG. 1 is a schematic view of a motor vehicle coolant circulation system.

FIG. 2 is a perspective view of a light emitting diode assembly for a vehicle lamp.

FIG. 3 is an exploded view of the light emitting diode assembly of FIG. 2 illustrating a possible coolant circulation path through the assembly.

### DETAILED DESCRIPTION

In the following detailed description, like reference numerals and characters may be used to designate identical, corresponding, or similar components in differing drawing figures.

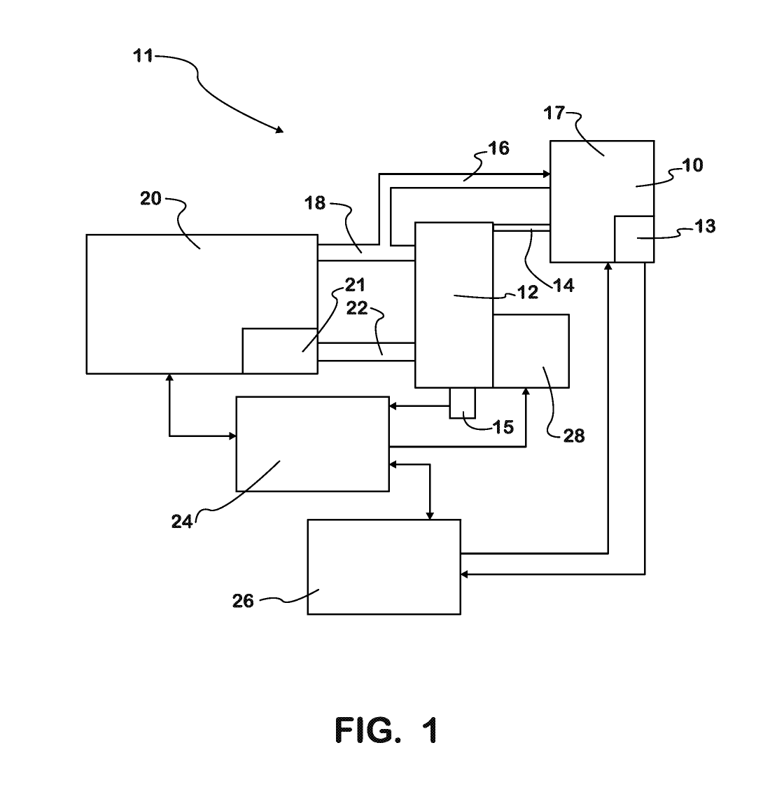

Referring now to the figures and in particular to FIG. 1, a motor vehicle coolant circulation system 11 is shown. Coolant circulation system 11 is connected to circulate engine coolant to an exterior lamp 10. The coolant circulation system 11 includes a radiator 12 which is intended at temperatures not to exceed a limit temperature T. Engine coolant flows out of radiator 12 into coolant circulation lines 14, 18 which are connected to the exterior lamp 10 and to an internal combustion (IC) engine 20, respectively. A coolant circulation line 16 carries coolant from lamp 10 to coolant circulation line 18 and through IC engine 20 to a pump 21 which forces the coolant into a coolant return line 22 for return to radiator 12.

Control over the coolant circulation system 11 resides in an engine control unit (ECU) 24 which, responsive to sensed coolant temperature from temperature sensor 15 can activate or deactivate a fan 28 positioned to force air through radiator 12. Variance of coolant temperature above the limit T results in fan 28 being turned on. Coolant temperature below T less an offset results in the fan being turned off if it is already on. After a warm up period radiator 12 usually operates in a constant temperature range.

ECU 24 communicates with an electrical system controller (ESC) 26 which in turn provides control signals for turning exterior lamp 10 on and off and which is connected to receive temperature measurements from lamp 10 from a temperature sensor 13. In some applications ESC 26 can control the amount of power delivered to lamp 10. ESC 26 can reduce the amount of power delivered to lamp 10, or turn lamp 10 off, in response to measured temperature from temperature sensor 13 exceeding a maximum limit.

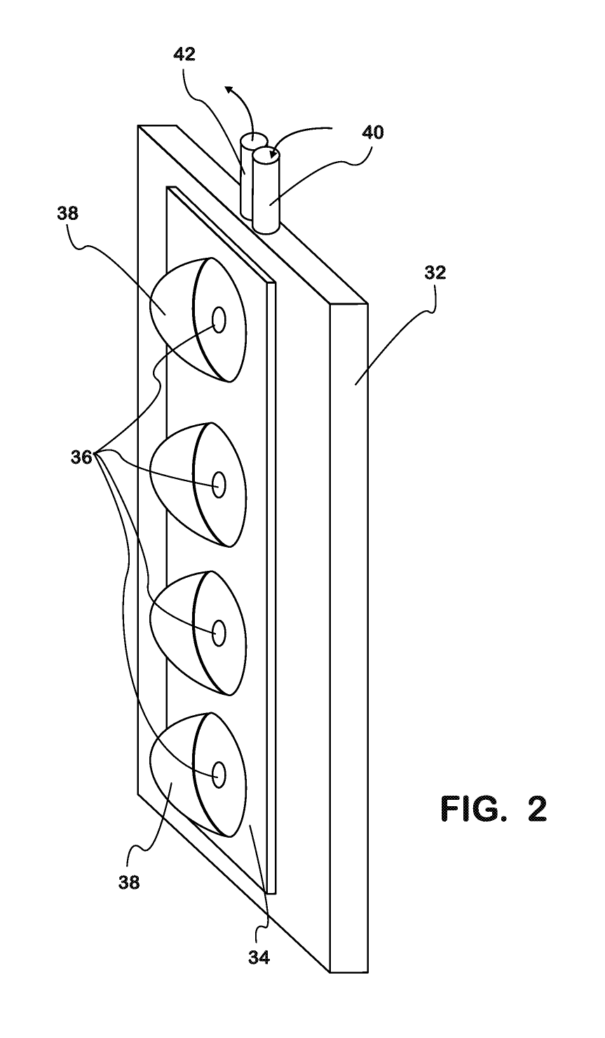

Lamp 10 includes a light emitting diode (LED) assembly 30 which is shown in FIG. 2. Lamp 10 may also include appropriate lenses (indicated generally as exterior surface 17), reflectors and shields (not shown) to shape and direct light beams allowing the lamp to be adapted for use as a headlamp, a tail light, a marker light, a turn signal light or any other (usually) exterior application. Radiator 12 serves as a source of coolant/liquid which is introduced to the LED assembly through inlet 40 at a substantially constant temperature and which maintains the temperature of lamp 10 within a range well above freezing but below the threshold temperature where LED efficiency drops substantially.

Reference to the liquid circulated through lamp 10 as “coolant” is conventional terminology for the water/alcohol mix used in engine cooling systems, however, the coolant can serve to transport heat either to or from LED assembly 30. For example, coolant serves to transport heat from radiator 12 to lamp 10 when the LED's 36 are off. This allows for conduction of heat to the exterior surface 17 which can keep the surface warmed and prevent ice and snow buildup on the exterior surface under cold weather conditions.

Referring to FIG. 2, an LED assembly 30 such as may be located in lamp 10 is shown in perspective view. LED assembly 30 comprises a housing 32, a circuit board 34 applied to a major face of the housing, and a plurality of light emitting diodes (LED's) 36 surface mounted on the circuit board 34. LED's 36 are encased in transparent epoxy lenses 38. A coolant inlet 40 and a coolant outlet 42 are connected to one end of the LED assembly 30 for in and out flow of engine coolant from the coolant circulation system 11 through the LED assembly 30.

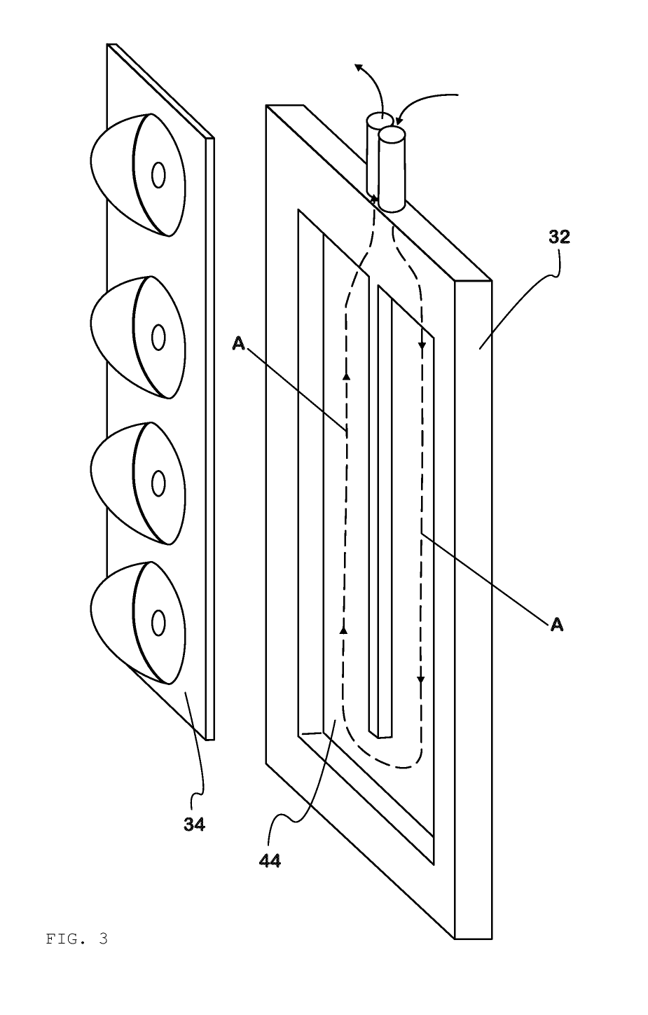

As illustrated in the partially exploded view of FIG. 3, circuit board 34 is applied to housing 32 directly over and covering a circulation cavity 44 within housing 32. Circulation cavity 44 is illustrated as open thereby exposing engine coolant to direct contact with the major surface of the circuit board opposite from the side of the circuit board to which LED's 36 are mounted. The circulation path of engine coolant in circulation cavity 44 within housing 32 is generally indicated by path “A.” Alternatively, the circulation cavity 44 may be enclosed within housing 32 excluding coolant inlet 40 and coolant outlet 42. Housing 32 may be made from a number of different materials, but is conveniently fabricated from aluminum. Circuit board 34 is usually made from a heat conducting metal.

When IC engine 20 is on and engine coolant has reached in normal operating range, circulation of the coolant through lamp 10 keeps the lamp 10 and LED assembly 30 in a temperature range with an upper limit, but warm enough to prevent ice and snow accumulation even when the LED's 36 are not energized. No convection heating of the exterior surface 17 need be provided and the LED's 36 do not need to be turned on to keep ice and snow off the lamp 10. The close proximity of the LED's 36 should keep the temperature of LED's 36 close to the coolant temperature under most conditions.

What is claimed is:

1. A lamp temperature control system comprising:
a light source;
means for supporting the light source;
a coolant circulation path through the means for supporting; and
an external source of coolant for circulation through the coolant circulation path which maintains coolant temperature upon entering the coolant circulation path at a substantially constant temperature.

2. The lamp temperature control system of claim 1, further comprising:
the external source of coolant includes a radiator and an internal combustion engine.

3. The lamp temperature control system of claim 2, wherein:
the light source is a light emitting diode assembly.

4. The light emitting diode assembly of claim 3, further comprising:
a housing including a coolant circulation cavity;
a circuit board mounted to the housing over the coolant circulation cavity; and
light emitting diodes mounted on the circuit board on a face of the circuit board disposed away

5. A motor vehicle lighting system comprising:
a circuit board;
one or more light emitting diodes mounted on the circuit board;
a housing supporting the circuit board;
a coolant circulation path routed through the housing;
the housing having connectors for connection to an external source of a circulating coolant;
a lamp having an external surface with the lamp containing the circuit board and the housing;
a radiator for circulating coolant through an engine; and
connectors between the lamp and the radiator for circulating coolant from the radiator through the lamp.

6. The motor vehicle lighting system of claim 5, further comprising:
the external surface providing a light transmission path out of the lamp.

7. A lamp comprising:
a mounting board;
one or more light emitting diodes supported on a major face of the mounting board;
a housing supporting the mounting board;
a cavity within the housing adjacent the mounting board;
an inlet to and an outlet from the cavity; and
means for circulating a fluid through the cavity by way of the inlet and the outlet.

8. The lamp of claim 7, further comprising:
an external source of coolant for circulation through the cavity; and
means for maintaining coolant introduced to the cavity at a substantially constant temperature.
